(19) United States
(12) Patent Application Publication
(10) Pub. No.: US 2017/0298567 A1
(43) Pub. Date: Oct. 19, 2017

(54) ELECTROCONDUCTIVE COATING

(71) Applicant: EEONYX CORPORATION, Pinole, CA (US)

(72) Inventor: Mahemuti Abula, Pittsburg, CA (US)

(21) Appl. No.: 15/445,614

(22) Filed: Feb. 28, 2017

Related U.S. Application Data
(60) Provisional application No. 62/301,482, filed on Feb. 29, 2016.

(51) Int. Cl. D06M 15/19; D01F 11/04; H01Q 1/27; H01Q 1/36; G06F 3/044

(52) U.S. Cl. CPC D06M 15/19; H01Q 1/273; H01Q 1/364; D01F 11/04; D06M 2200/00; D10B 2401/16; G06F 3/044

(57) ABSTRACT

The invention relates to an electroconductive staple fibers, fabrics and other substrates. The invention further relates to fibers fabrics and other articles of manufacture produced using the method. The method and articles of manufacture find particular use in functional wearable garments, e.g., outerwear, gloves, and in devices in which electroconductivity is desirable. Exemplary devices include a fiber, fabric or leather substrate or component.

### BACKGROUND OF THE INVENTION

### Field of the Invention

The present invention relates generally to substrates (e.g., fibers and fabric) coated with an electroconductive polymer, which conduct electricity. Such an article may find application in the manufacture of antistatic clothes, static charge removal and radio-interference prevention shields of electrical and electronic devices, pressure sensors etc. The invention also relates to a method of manufacturing the aforementioned electroconductive articles.

### Description of the Prior Art

Electroconductive fabric and fibers are of use in textile-based electronics, called “electrotextiles.” Fibers and fabrics with useful electroconductive properties are components of multifunctional fiber assemblies that can sense, actuate, communicate, etc. Wired interconnections of different devices attached to the conducting elements of these circuits are made by arranging and weaving conductive threads so that they follow desired electrical circuit designs.

Electroconductive fabrics are also of use for preventing the build up or removing electrostatic charge from the body of the wearer. As such, electroconductive fibers and fabrics find use in clean rooms, e.g., on assembly lines of printed circuit boards, or the like. Electroconductive fabrics prevent accumulation of an electric charge and thus the possibility of undesired discharge, e.g., a gas discharge in the operation environment of a clean room. Such discharges may destroy an intricate circuit of electronic device components at the production stage due to sensitivity of the device to electromagnetic discharge.

Electric discharges caused by the accumulation of static electricity can cause an explosion in environments characterized by the presence of vapors of highly volatile liquids, e.g., gasoline, alcohols, explosives, TNT etc. A small spark caused by the discharge of static electricity from clothes can cause an explosion of gasoline or other vapors accumulated in the ambient air.

Static electricity is also an environmental nuisance; people receive unexpected shocks, simply by touching a metal object or another person after walking across a carpet. When certain materials rub together, they build up static electricity. Items known to cause build up of static electricity include clothes rubbing on human skin, furniture and car seats, and soles of shoes rubbing against a rug or floor, etc.

Another example of an application of electroconductive fabric is custom seats. In order to combat static electricity buildup in standard wool seat covers, Oregon Aero Co. developed the Anti-Static Inner Upholstery which draws off the static charge and directs it to the seat frame. This is especially important for aircraft seats that are packed with extensive electronic equipment and need anti-static inner upholstery.

There are many other exemplary applications for electroductive fabrics, such as heating sportswear, in the lining of the casings of electronic devices for shielding against electromagnetic radiation to prevent electromagnetic interference with radio receivers, TV sets, telephones, etc., cable shielding, and military uses for special devices equipped with protective electroconductive fabric coatings that provide a predetermined electromagnetic impedance thereby screening against radio location.

Electroconductive fabrics are also of use in cellular communications. For example, Soft-Shield 5000 EMI gaskets (Chomerics), which shielding he electronic enclosures used in cellular communications. The gaskets consist of an electrically conductive fabric jacket over soft urethane foam.

Electroconductive fibers and fabrics are components of functional garments. For example, a sensor garment including a conductive element. The conductive element may be formed from a conductive polymer or conductive fabric. The conductive element includes a first termination point at the device retention element, configured to connect to a monitor device. The conductive element includes a second termination point configured to connect to a sensor or transceiver. See, U.S. Patent Application Publication No. 2015/006,7943

Another exemplary functional garment includes flexible, fabric-encapsulated light arrays particularly suitable for uses in clothing are disclosed. The light arrays are light-emitting diode (LED) arrays disposed on flexible printed circuit boards (PCBs). The light arrays are contained within pockets that may be made of conductive fabric in order to form a Faraday cage. Systems and methods are also disclosed that use local and wide-area controllers to send words, images, and video to the light arrays substantially in real time. U.S. Patent Application Publication No. 2014/0340,877.

Heretofore, conductive fabrics useful for, as an example, dissipation of static electricity, have incorporated monofilaments with high loadings of conductive materials, such as carbon black or metallic particulate. Typically, these conductive materials are either dispersed within a base polymer, such as polyethylene terephthalate and polyamide, or incorporated in polymeric coatings which are deposited over oriented monofilaments.

There are several limitations associated with prior methods. First, the conductivity of the loaded monofilaments is only in the range of 10⁻⁴-10⁻⁷ S/cm, which is the minimum needed for effective dissipation of static charge. Unfortunately, this drawback limits the fabric design options, and also impairs fabric performance. A second disadvantage is that, in the case of fully filled products, there is a compromise of monofilament physical properties, such as modulus, tenacity and elongation. This is due to the high level of contamination caused by compounding levels greater than twenty percent of the conductive filler. This loss of physical properties, again, restricts the options for fabric design and negatively impacts fabric performance. A further shortcoming associated with known conductive fabrics is that highly loaded carbon-based coatings exhibit both poor abrasion and inferior adhesion properties. Consequently, the fabric's durability along with its dissipation properties both suffer.

Known conductive fabrics incorporate conductive coatings, metallic wire constructions, or combination designs incorporating metallic additive fibers within a synthetic structure. There are, however, drawbacks also associated with these fabrics. For example, while these prior designs may dissipate static charge, it is noted that structures with metallic wires are difficult to manufacture. A further disadvantage is that metal-based fabrics are easily damaged, and in particular, incur unwanted dents and creases during use. Previous coated designs, on the other hand, have suffered from a lack of durability and also interfere with the permeability of open mesh structures.

The incorporation of electrically conductive polymers into fabrics presents a potential solution to the forgoing problems. In this connection, conductive polymers are available either as the polymer itself or a doped form of a conjugated polymer. Additionally, conductivities as high as 30-35×10³ S/cm have been achieved using these polymers, which is only an order of magnitude below the conductivity of copper. However, in addition to being sufficiently conductive, the polymer must also be stable in air at use temperature and so retain its conductivity over time. Also, the conductive polymer material must be processable, and have sufficient mechanical properties for a particular application and, ideally, be washable and wear resistant.

In spite of a great variety of methods for manufacturing and treating electroconductive textiles, there is still room for the improvement. For example, a common disadvantage which remains for the conventional electroconductive textile is that with the lapse of time electrical characteristics are impaired, at least in some applications. Another disadvantage of the known electroconductive fabrics is that they are insufficiently stable to environmental conditions, such as humidity and temperature. In many instances, electroconductive textile materials are not sufficiently durable to laundering. This is because the dopant used in the above method is leachable, i.e., has water-soluble molecules. The present invention solves these and other problems

### SUMMARY OF THE INVENTION

It is an object of the invention to provide an electroconductive textile material that does not lose its electrical characteristics with the lapse of time. It is another object of the invention to provide an electroconductive fabric that is stable to environmental conditions, such as humidity, temperature and ultraviolet radiation. It is another object to provide a method of manufacturing electroconductive textile material that allows easy control of electrical resistivity of the material. It is a further object of the invention to provide an electroconductive textile material and a method of manufacturing thereof that allow one to obtain such aforementioned material with chosen electrical characteristics. It is a further object of the invention to provide the method of manufacturing an electroconductive fabric with the use of a layer-by-layer technique that does not necessarily change or impair the properties of the fabric substrate, such as color, strength, etc.

In various embodiments, there is provided an electroconductive staple fiber, comprising, (a) a staple fiber substrate, stably coated with (b) an electroconductive organic polymer, comprising (i) a charged organic polymer bearing a plurality of charged moieties of a first polarity; (ii) a charged organic dopant molecule bearing a charge of a second polarity, wherein the first polarity is opposite the second polarity; and (c) a polymeric binder coating at least a portion of the electroconductive polymer.

In various embodiments, there is provided a method for making an electroconductive staple fiber. An exemplary method includes coating a fiber substrate with: (a) an electroconductive polymeric coating comprising, (i) a charged organic polymer bearing a plurality of charged moieties of a first polarity; (ii) a charged organic dopant molecule bearing a charge of a second polarity, wherein the first polarity is opposite the second polarity, under conditions sufficient to adhere the electroconductive polymer to the fiber substrate; and (b) a polymeric binder, under conditions sufficient to adhere the polymeric binder to at least a portion of the electroconductive polymer coated on the fiber substrate.

The fabrics used for EC purposes may be woven, non-woven, synthetic and natural, etc. There are many methods of manufacturing. The fabric can be woven entirely from electroconductive threads, or electroconductive threads can be interweaved with conventional threads. In addition, the electroconductive fabric may have different patterns of weaving, etc.

In a further embodiment, the invention provides an electroconductive fiber, textile or leather article, comprising: (a) a textile or leather substrate, stably coated with, (b) an optically transparent electroconductive organic polymer, comprising: (i) an organic polymer bearing a plurality of aromatically conjugated moieties; and (ii) a charged organic dopant molecule, wherein the optically transparent electroconductive organic polymer is essentially clear and colorless in appearance.

In various embodiments, the invention provides a method of forming an electroconductive fiber, textile or leather article. The method includes: (a) coating a fiber, textile or leather substrate with, (i) an optically transparent electroconductive organic polymer comprising a plurality of aromatically conjugated moieties; and (ii) a charged organic dopant molecule, wherein the optically transparent electroconductive organic polymer is essentially clear and colorless in appearance.

In various embodiments, the electroconductive coating does not impair the basic function of the substrate or the object it used to construct. For example, in the case of clothing, and wearable accessories the fabric and fibers provides an attractive appearance, have wearability, and in sport-wear be lightweight and durable, etc.

The conductive coatings obtained by the method of the invention are uniform and more stable to UV light, laundering, heat and humidity. Excellent adhesion to the substrate makes these coatings clean for electronics applications (i.e., no contaminants: particulates and leachable ions).

Other embodiments, objects and advantages of the invention will be apparent from the detailed description that follows.

### DETAILED DESCRIPTION OF THE INVENTION

### Introduction

Capacitive touch-sensitive electronic device displays have revolutionized the way that we interact with electronic devices in applications ranging from mobile phones to ATMs. These user input devices can be integrated directly into a display screen, and they allow for powerful, intuitive, and direct control of what is actually displayed on the screen without the need for additional peripheral hardware such as a keyboard, mouse, or stylus. One disadvantage of capacitive touch-sensitive displays is that they require a charge-conducting input mechanism (e.g., the human body) to distort the screen's electrostatic field. Thus, capacitive touch-sensitive displays cannot be controlled by products that are electrically insulating, such as gloves, plastic styluses, etc.

According to the present invention conductivity can be imparted to fiber, textile and leather materials. When the substrate is a fabric, the fabric substrate can be woven or non-woven, natural or synthetic, etc. More specifically, the fabrics suitable for obtaining conductivity by the method of the invention may be woven fabric, non-woven fabric, natural fabric such as cotton, wool, and silk, synthetic fabric such as nylon, polyester, polypropylene, Kevlar, and lycra-spandex, fabric that contains both natural and synthetic fiber, or inorganic material fabric such as glass fiber fabric, quartz fiber fabric, etc.

In its initial state, the fiber or fabric substrate can be inherently neutral or charged positively or negatively. If the substrate is initially neutral, a special treatment is carried out for making it charged in accordance with the embodiment of the method of the invention with subsequent treatment.

### Definitions

Before the invention is described in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided might be different from the actual publication dates, which may need to be independently confirmed.

It is noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order that is logically possible. Although any methods and materials similar or equivalent to those described herein may also be used in the practice or testing of the invention, representative illustrative methods and materials are now described.

In describing the present invention, the following terms will be employed, and are intended to be defined as indicated below.

As used in this specification and the appended claims, the singular forms “a”, “an” and “the” include plural referents unless the content explicitly dictates otherwise. Thus, for example, reference to “cationic nickel catalyst” includes a mixture of two or more such compounds, and the like.

Where substituent groups are specified by their conventional chemical formulae, written from left to right, the structures optionally also encompass the chemically identical substituents, which would result from writing the structure from right to left, e.g., —CH₂O— is intended to also recite —OCH₂—.

The term “alkyl,” by itself or as part of another substituent, means, unless otherwise stated, a straight or branched chain, or cyclic hydrocarbon radical, or combination thereof, which may be fully saturated, mono- or polyunsaturated and can include di-, tri- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.” Alkyl groups that are limited to hydrocarbon groups are termed “homoalkyl”. Exemplary alkyl groups include the monounsaturated C₉₋₁₀, oleoyl chain or the diunsaturated C_{9-10, 12-13} linoeyl chain.

The term “alkylene” by itself or as part of another substituent means a divalent radical derived from an alkane, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The terms “alkoxy,” “alkylamino” and “alkylthio” (or thioalkoxy) are used in their conventional sense, and refer to those alkyl groups attached to the remainder of the molecule via an oxygen atom, an amino group, or a sulfur atom, respectively.

The terms “aryloxy” and “heteroaryloxy” are used in their conventional sense, and refer to those aryl or heteroaryl groups attached to the remainder of the molecule via an oxygen atom.

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —CO₂R′— represents both —C(O)OR′ and —OC(O)R′.

The terms “cycloalkyl” and “heterocycloalkyl”, by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopentyl, cyclohexyl, 1-cyclohexenyl, 3-cyclohexenyl, cycloheptyl, and the like. Further exemplary cycloalkyl groups include steroids, e.g., cholesterol and its derivatives. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like.

The terms “halo” or “halogen,” by themselves or as part of another substituent, mean, unless otherwise stated, a fluorine, chlorine, bromine, or iodine atom. Additionally, terms such as “haloalkyl,” are meant to include monohaloalkyl and polyhaloalkyl. For example, the term “halo(C₁-C₄)alkyl” is mean to include, but not be limited to, trifluoromethyl, 2,2,2-trifluoroethyl, 4-chlorobutyl, 3-bromopropyl, and the like.

The term “aryl” or “arene” means, unless otherwise stated, a polyunsaturated, aromatic, substituent that can be a single ring or multiple rings (preferably from 1 to 3 rings), which are fused together or linked covalently. The term “heteroaryl” or “heteroarene” refers to aryl groups (or rings) that contain from one to four heteroatoms selected from N, O, S, Si and B, wherein the nitrogen and sulfur atoms are optionally oxidized, and the nitrogen atom(s) are optionally quaternized. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

For brevity, the term “aryl” when used in combination with other terms (e.g., aryloxy, arylthioxy, arylalkyl) includes both aryl and heteroaryl rings as defined above. Thus, the term “arylalkyl” is meant to include those radicals in which an aryl group is attached to an alkyl group (e.g., benzyl, phenethyl, pyridylmethyl and the like) including those alkyl groups in which a carbon atom (e.g., a methylene group) has been replaced by, for example, an oxygen atom (e.g., phenoxymethyl, 2-pyridyloxymethyl, 3-(1-naphthyloxy)propyl, and the like).

Each of the above terms (e.g., “alkyl,” “heteroalkyl,” “heteroarene”, “aryl”, “arene” and “heteroaryl”) are meant to optionally include both substituted and unsubstituted forms of the indicated radical. Exemplary substituents for each type of radical are provided below. The discussion regarding aryl and heteroaryl radicals is relevant to embodiments in which an arene or heteroarene is the substrate.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) are generically referred to as “alkyl group substituents,” and they can be one or more of a variety of groups selected from, but not limited to: H, substituted or unsubstituted aryl, substituted or unsubstituted heteroaryl, substituted or unsubstituted heterocycloalkyl, —OR′, ═O, ═NR′, ═N—OR′, —NR′R″, —SR′, halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR′″″, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R′″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like). These terms encompass groups considered exemplary “alkyl group substituents”, which are components of exemplary “substituted alkyl” and “substituted heteroalkyl” moieties.

Similar to the substituents described for the alkyl radical, substituents for the aryl and heteroaryl groups and arene and heteroarene substrates are generically referred to as “aryl group substituents.” The substituents are selected from, for example: H, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R′″ and R″″ groups when more than one of these groups is present.

Two of the substituents on adjacent atoms of the aryl or heteroaryl ring may optionally be replaced with a substituent of the formula -T-C(O)—(CRR′)_{q}—U—, wherein T and U are independently —NR—, —O—, —CRR′— or a single bond, and q is an integer of from 0 to 3. Alternatively, two of the substituents on adjacent atoms of the aryl or heteroaryl ring may optionally be replaced with a substituent of the formula -A-(CH₂)ᵣ—B—, wherein A and B are independently —CRR′—, —O—, —NR—, —S—, —S(O)—, —S(O)₂—, —S(O)₂NR′— or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X—(CR″R′″)₂—, where s and d are independently integers of from 0 to 3, and X is —O—, —NR′—, —S—, —S(O)—, —S(O)₂—, or —S(O)₂NR′—. The substituents R, R′, R″ and R″ are preferably independently selected from hydrogen or substituted or unsubstituted (C₁-C₆)alkyl. These terms encompass groups considered exemplary “aryl group substituents”, which are components of exemplary “substituted aryl” and “substituted heteroaryl” moieties.

As used herein, the term “acyl” describes a substituent containing a carbonyl residue, C(O)R. Exemplary species for R include H, halogen, substituted or unsubstituted alkyl, substituted or unsubstituted aryl, substituted or unsubstituted heteroaryl, and substituted or unsubstituted heterocycloalkyl.

As used herein, the term “fused ring system” means at least two rings, wherein each ring has at least 2 atoms in common with another ring. “Fused ring systems may include aromatic as well as non aromatic rings. Examples of “fused ring systems” are naphthalenes, indoles, quinolines, chromenes and the like.

As used herein, the term “heteroatom” includes oxygen (O), nitrogen (N), sulfur (S) and silicon (Si), phosphorus (P), and boron (B).

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

The term “salt(s)” includes salts of the compounds prepared by the neutralization of acids or bases, depending on the particular ligands or substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. When compounds of the present invention contain relatively basic functionalities, acid addition salts can be obtained by contacting the neutral form of such compounds with a sufficient amount of the desired acid, either neat or in a suitable inert solvent. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present invention contain both basic and acidic functionalities that allow the compounds to be converted into either base or acid addition salts. Hydrates of the salts are also included.

The invention is further directed, in part, to fabrics that include filaments or yarns of the present invention, and articles that include fabrics of the present invention. For purposes herein, “fabric” means any woven, knitted, or non-woven structure. By “woven” is meant any fabric weave, such as, plain weave, crowfoot weave, basket weave, satin weave, twill weave, and the like. By “knitted” is meant a structure produced by interlooping or intermeshing one or more ends, fibers or multifilament yarns. By “non-woven” is meant a network of fibers, including unidirectional fibers (if contained within a matrix resin), felt, and the like.

“Fiber” means a relatively flexible, unit of matter having a high ratio of length to width across its cross-sectional area perpendicular to its length. Herein, the term “fiber” is used interchangeably with the term “filament”. The cross section of the filaments described herein can be any shape, but are typically circular or bean shaped. Fiber spun onto a bobbin in a package is referred to as continuous fiber. Fiber can be cut into short lengths called staple fiber. Fiber can be cut into even smaller lengths called floc. The term “yarn” as used herein includes bundles of filaments, also known as multifilament yarns; or tows comprising a plurality of fibers; or spun staple yarns. Yam can be intertwined and/or twisted.

As used herein, the term “modacrylic fiber” refers to an acrylic synthetic fiber made from a polymer comprising primarily residues of acrylonitrile. Modacrylic fibers are spun from an extensive range of copolymers of acrylonitrile. The modacrylic fiber may contain the residues of other monomers, including vinyl monomer, especially halogen-containing vinyl monomers, such as but not limited to vinyl chloride, vinylidene chloride, vinyl bromide, vinylidene bromide, and the like. The types of modacrylic fibers that can be produced within this broad category are capable of wide variation in properties, depending on their composition. Some examples of commonly available modacrylics are PROTEX™, KANEKALON™, and KANECARON™ by Kaneka Corporation, PYROTE™, and Formosa Plastics.

As used herein, the term “aramid fiber” refers to a manufactured fiber in which the fiber-forming substance is a long-chain synthetic polyamide in which at least 85% of the amide linkages, (—CO—NH—), are attached directly to two aromatic rings.

Suitable fibers may include at least one polymer selected from the group consisting of polypropylene, polyethylene terephthalate, polybutylene terephthalate, poly(trimethylene terephthalate), polylactide, nylon, polyacrylonitrile, polybenzimidazole (PBI), fluoropolymer, and copolymers thereof, and combinations thereof. An exemplary fiber is a combination of modacrylic and nylon.

Further exemplary fibers include those selected from cellulose, cellulose derivative (such as cotton, viscose, linen, rayon, fire-resistant rayon, lyocell, or a combination thereof), wool, and copolymers thereof, and combinations thereof. Preferably, the hydrophilic fiber comprises cotton or fire-resistant rayon, or a combination thereof. In certain embodiments, the hydrophilic fiber is a cellulose derivative, including but not limited to, cotton, viscose, linen, rayon, or a combination thereof. In certain embodiments, the hydrophilic fiber is cotton, especially cotton that has not been treated with a fugitive fire resistant treatment.

As used herein, the term “antistatic fiber” refers to a fiber, when incorporated into a fabric or other material, eliminates or reduces static electricity. Suitable fibers include, but are not limited to, metal fibers (steel, copper or other metal), metal-plated polymeric fibers, and polymeric fibers incorporating carbon black on the surface and/or in the interior of the fiber, such as those described in U.S. Pat. Nos. 3,803,453, 4,035,441, 4,107,129, and the like. Antistatic carbon fiber is a preferred antistatic fiber. One example of such conductive fiber is NEGASTATR™ produced by E.I. du Pont de Nemours and Company, a carbon fiber comprising a carbon core of conductive carbon surrounded by non-conductive polymer cover, either nylon or polyester. Another example is RESISTAT™ made Shakespeare Conductive Fibers LLC, a fiber where the fine carbon particles are embossed on the surface of a nylon filament. The yarns of both such fibers are available in a denier of at least 40. By way of example, a steel wire is available under the names BEKINOX and BEKITEX from Bekaert S. A. in a diameter as small as 0.035 millimeter. Another antistatic fiber is the product X-static made by Noble Fiber Technologies, a nylon fiber coated with a metal (silver) layer. The X-static fibers may be blended with other fibers, such as modacrylics, in the process of yarn spinning.

As used herein, the term “basis weight” refers to a measure of the weight of a fabric per unit area. Typical units include ounces per square yard and grams per square meter.

As used herein, the term “garment” refers to any article of clothing or clothing accessory worn by a person, including, but not limited to shirt, pants, underwear, outer wear, footwear, headwear, swimwear, belts, gloves, headbands, and wristbands, especially those used as protective wear or gear.

As used herein, the term “linen” (when not referring to the hydrophilic fiber) refers to any article used to cover a worker or seating equipment used by workers, including, but not limited to sheets, blankets, upholstery covering, vehicle upholstery covering, and mattress covering.

As used herein, the term “intimate blend,” when used in conjunction with a yarn, refers to a statistically random mixture of the staple fiber components in the yarn.

### The Embodiments

### The Fibers and Fabrics

In an exemplary embodiment, there is provided an electroconductive staple fiber, comprising, (a) a staple fiber substrate, stably coated with (b) an electroconductive organic polymer, comprising (i) a charged organic polymer bearing a plurality of charged moieties of a first polarity; (ii) a charged organic dopant molecule bearing a charge of a second polarity, wherein the first polarity is opposite the second polarity; and (c) a polymeric binder coating at least a portion of the electroconductive polymer.

In various embodiments, the invention provides a staple fiber, wherein the staple fiber substrate comprises, a natural fiber, a synthetic fiber, and combination thereof.

The electrically conductive polymer can be, according to some embodiments, any suitable electrically conducting polymer such as poly(3,4-ethylenedioxythiophene), polyfluorenes, polyphenylenes, polypyrenes, polyazulenes, polynaphthalenes, polypyrroles, polycarbazoles, polyindoles, polyazepines, polyanilines, poly(thiophene)s, or poly(p-phenylene sulphide).

The coating mixture used to coat the fiber, fabric or other substrate may also include one or more dispersing agents (e.g., non-ionic, anionic, cationic and/or amphoteric surfactants), aqueous based acrylics and/or polyurethane resins, binders, fillers and waxes, water miscible solvents, and/or water.

In various embodiments, the invention provides a staple fiber, wherein the electroconductive polymer is a member selected from polyanionic polymers and polycationic polymers.

Examples of polyanionic polymers suitable for the compositions are the following: aqueous or non-aqueous solutions of poly(2-acrylamido-2-methyl-1-propanesulfonic acid), poly(2-acrylamido-2-methyl-1-propanesulfonic acid-co-acrylonitrile), poly(2-acrylamido-2-methyl-1-propanesulfonic acid-co-styrene), poly(acrylic acid), sodium salts of polyacrylic acid having different molecular weights, sodium salt of poly(anetholesulfonic acid), poly(anilinesulfonic acid), poly(sodium 4-styrenesulfonate), poly(styrene-alt-maleic acid) sodium salt, poly(4-styrenesulfonic acid), poly(4-styrenesulfonic acid) ammonium salt, poly(4-styrenesulfonic acid) lithium salt, poly(4-styrenesulfonic acid) sodium salt, poly(4-styrenesulfonic acid-co-maleic acid) sodium salt, poly(vinyl sulfate) potassium salt, poly(vinylsulfonic acid) sodium salt, heparin etc.

Examples of polycationic polymers are the following: aqueous or non-aqueous solutions of poly(acrylamide-co-diallyidimethylammonium chloride), poly(allylamine hydrochloride), poly(diallyldimethylammonium chloride), and manganese(II) hexafluoroacetyl acetonate trihydrate, poly(vinylpyridine), polyethyleneimine, etc.

In an exemplary embodiment, the invention provides a staple fiber, wherein the electroconductive polymer is a doped polymer. In an exemplary embodiment, the conductive doped polymer is polycationic polymer and the dopant is an anionic organic compound.

In various embodiments, the invention provides a staple fiber, wherein the charged organic dopant molecule is a member selected from substituted or unsubstituted arenes and substituted or unsubstituted heteroarenes. An exemplary charged organic dopant molecule is a substituted or unsubstituted quinone, e.g., substituted anthraquinone. An exemplary substituted anthraquinone is a salt of anthraquinone-2-sulfonic acid.

In an exemplary embodiment, the invention provides a staple fiber, wherein the electroconductive polymer is a member selected from poly(substituted or unsubstituted arenes), and poly(substituted or unsubstituted heteroarenes). An exemplary electroconductive polymer is polypyrrole.

Examples of negatively charged doped conductive polymers are the following: aqueous dispersion of poly(anilinesulfonic acid), polyaniline doped with excess of ligninsulfonic acid, polypyrrole doped with poly(styrenesulfonic) acid, polythiophene doped with exess of poly(styrenesulfonic) acid, poly(ethylenedioxythiophene) doped with exess of poly(styrenesulfonic) acid.

Examples of useful positively charged doped conductive polymers are the following: aqueous dispersion of polyaniline doped with methanesulfonic acid, aqueous dispersion of polypyrrole doped with methanesulfonic acid.

In various embodiments, the invention provides a staple fiber, wherein the monomer:dopant ratio of the fiber is from about 3:1 to about 1:4.

In an exemplary embodiment, the invention provides a staple fiber, wherein the monomer: binder ratio is from about 1:0.2 to about 1:4.

In various embodiments, the invention provides a staple fiber, wherein the conductivity of the fiber is from about 10 ohm/m² to about 10⁸ ohm/m².

In an exemplary embodiment, the invention provides a staple fiber, wherein the binder polymer is a member selected from polymeric alkyl alcohols, polymeric aryl alcohols, and polymeric heteroaryl alcohols.

In various embodiments, the invention provides a staple fiber, wherein the binder is poly(vinyl alcohol).

In an exemplary embodiment, the binder is present during polymerization and a portion of the total amount of the binder is entrained within or otherwise immobilized by the conductive polymer during the polymerization process. Generally, binder not immobilized by the conductive polymer forms a coating with the conductive polymer upon application of the conductive polymer/binder mixture to the substrate.

In various embodiments, the invention provides a staple fiber, wherein the staple fiber is a member of a plurality of staple fibers.

In an exemplary embodiment, the invention provides a staple fiber, wherein the stable fiber is a component of a woven or non-woven fabric.

In various embodiments, the invention provides an electroconductive fiber, textile or leather article, comprising: (a) a textile or leather substrate, stably coated with, (b) an optically transparent electroconductive organic polymer, comprising: (i) an organic polymer bearing a plurality of aromatically conjugated moieties; and (ii) a charged organic dopant molecule, wherein the optically transparent electroconductive organic polymer is essentially clear and colorless in appearance.

In an exemplary embodiment, the invention provides an electroconductive fiber, textile or leather article, wherein the aromatically conjugated moieties are members selected from substituted or unsubstituted aryl, substituted or unsubstituted heteroaryl moieties, and a combination thereof.

In various embodiments, the invention provides an electroconductive fiber, textile or leather article, wherein the aromatically conjugated moieties are substituted thiophene moieties.

In an exemplary embodiment, the invention provides an electroconductive fiber, textile or leather article, wherein the electroconductive organic polymer is poly(3,4-ethylenedioxythiophene).

In various embodiments, the invention provides an electroconductive fiber, textile or leather article, wherein the dopant is a member selected from a polycationic polymer, a polyanionic polymer and a combination thereof.

In various embodiments, the invention provides an electroconductive textile or leather article, wherein the charged organic dopant molecule is a poly(sulfonic acid).

In an exemplary embodiment, the invention provides an electroconductive textile or leather article, wherein the charged organic dopant molecule is poly(styrenesulfonic acid).

In various embodiments, the invention provides an electroconductive textile or leather article, wherein the article is a textile article and the substrate is a member selected from a fiber, a non-woven fabric, and a woven fabric.

In various embodiments, the staple fibers described above are incorporated into a garment. An exemplary garment is a glove. In an exemplary glove, the conductive staple fibers are incorporated into a region of the glove that will come into contact with a touch screen, e.g., mobile phone, tablet, ATM, etc., while the user is wearing the glove. Thus, in order to interface with the touch screen it is not necessary for the wearer of the glove to remove the glove.

In various embodiments, the invention provides a composition in which the substrate is other than a fiber, fabric or leather. Other substrates include materials for construction or decoration. In an exemplary embodiment, the coated material of the invention is coated bamboo charcoal. Other coated charcoals include, without limitation, common charcoal, sugar charcoal, activated charcoal, lump charcoal, Japanese charcoal (e.g. Ogatan), pillow shaped briquets, hexagonal sawdust briquettes and extruded charcoal.

In an exemplary embodiment, the invention provides an electroconductive textile or leather article, having a surface resistance of from about 10 Ohms/sq to about 10⁶ Ohms/m².

In various embodiments, the invention provides an electroconductive textile or leather article, wherein the article is capable of transferring magnetic energy.

In various embodiments, the invention provides an antenna comprising an electroconductive fiber or fabric of the invention.

### The Methods

In various embodiments, there is provided a method for making an electroconductive staple fiber. An exemplary method includes coating a fiber substrate with: (a) an electroconductive polymeric coating comprising, (i) a charged organic polymer bearing a plurality of charged moieties of a first polarity; (ii) a charged organic dopant molecule bearing a charge of a second polarity, wherein the first polarity is opposite the second polarity, under conditions sufficient to adhere the electroconductive polymer to the fiber substrate; and (b) a polymeric binder, under conditions sufficient to adhere the polymeric binder to at least a portion of the electroconductive polymer coated on the fiber substrate.

In various embodiments, the invention provides a method of making a staple fiber, wherein the coating of the fiber substrate is obtained by polymerizing a polymerizable monomer precursor for the electroconductive polymer in contact with the fiber substrate under conditions sufficient to coat the fiber substrate with a polymer coating formed by polymerization of the monomer precursor.

In an exemplary embodiment, the invention provides a method of making a staple fiber, wherein the polymerizing is obtained via oxidative polymerization of the monomer precursor using an oxidant. Exemplary oxidants of use include, without limitation, FeCl₃, Fe(NO₃)₃, Fe₂(SO₄)₃, (NH₄)₂Ce(NO₃)₆, CrO₃, CuCl₂ and combinations thereof.

In an exemplary embodiment, a dopant is entrained in the polymer upon polymerization of the polymerizable monomer. In one embodiment, the polymer is a poly(pyrrole) prepared under oxidative polymerization conditions. The dopant is captured by chare-charge interaction between oppositely charged moieties on the growing polymer and the dopant, thereby forming the doped polymer. An exemplary dopant is a substituted or unsubstituted anthraquinone, e.g., anthraquinone-2-sulfonic acid.

In various embodiments, the invention provides a method of making a staple fiber, wherein the polymer coating is essentially electrically neutral, and comprises a plurality of basic or acidic moieties.

In an exemplary embodiment, the invention provides a method of making a staple fiber, wherein, prior to step (b), the polymer is contacted with a member selected from an acid and a base of sufficient strength to protonate at least a portion of the plurality of basic moieties or deprotonate at least a portion of the plurality of acidic moieties on the polymer.

In various embodiments, the invention provides a method of making a staple fiber, wherein the monomer:fiber ratio is from about 1:500 to about 1:5.

In various embodiments, the invention provides a method of making a staple fiber, wherein the monomer:dopant ratio is from about 3:1 to about 1:4.

In an exemplary embodiment, the invention provides a method of making a staple fiber, wherein the monomer:catalyst ratio is from about 1:7 to about 1:25.

In various embodiments, the invention provides a method of forming an electroconductive fiber, textile or leather article. The method includes: (a) coating a textile or leather substrate with, (i) an optically transparent electroconductive organic polymer comprising a plurality of aromatically conjugated moieties; and (ii) a charged organic dopant molecule, wherein the optically transparent electroconductive organic polymer is essentially clear and colorless in appearance. The method employs the same components, or components similar to those set forth above.

After the conductive coating is applied, the conductive leather material may be subjected to dying and/or drying, and a series of physical and mechanical operations including spraying water onto the back of the material, ironing, milling (e.g., placing the conductive material into a drum and rotating the drum above 25 rpm), and mechanical softening (e.g., staking).

Similar processing may be applied across a range of types of materials including woven and non-woven textiles and fabrics, including natural fabrics (e.g., cotton, wool, etc.), synthetic fabrics (nylon, rayon, etc.), non-woven materials (e.g., felt, synthetic leather, etc.), and leather. Moreover, although the disclosure above refers to specific base, middle, and top layers, more fluid distinctions may be appropriate in some embodiments. For example, concentrations of certain materials may be varied within the same layer, and one or more of the materials discussed with respect to a specific layer may also be included in one or more of the other layers. The layer appellations are meant to provide convenient points of reference for a general process flow that may be altered slightly without straying from the spirit of the embodiments disclosed herein.

Using the processes described above solves several issues that have thus far proven problematic for forming conductive materials for use in various articles of manufacture (e.g., wearables, household textiles, e.g., carpeting, linens, etc.). In particular, the above-described process results in conductive materials with appropriate color saturation, color fastness, and conductivity resilience.

In various embodiments, the invention provides a method of forming an electroconductive textile or leather article, wherein the aromatically conjugated moieties are members selected from substituted or unsubstituted aryl, substituted or unsubstituted heteroaryl moieties, and a combination thereof.

In various embodiments, the method described above is utilized to prepare conductive fibers, fabric or leather, and incorporating the material into a garment. An exemplary garment is a glove. In an exemplary glove, the conductive staple fibers are incorporated into a region of the glove that will come into contact with a touch screen, e.g., mobile phone, tablet, ATM, etc., while the user is wearing the glove. Thus, in order to interface with the touch screen it is not necessary for the wearer of the glove to remove the glove.

In various embodiments, the invention provides a composition in which the substrate is other than a fiber, fabric or leather. Other substrates include materials for construction or decoration. In an exemplary embodiment, the coated material of the invention is coated bamboo charcoal.

In an exemplary embodiment, the conductive material includes at least one species in which the aromatically conjugated moieties are substituted thiophene moieties. An exemplary electroconductive organic polymer is poly(3,4-ethylenedioxythiophene).

As set forth herein, the method includes the use of a dopant to form the electroconductive polymer. Exemplary dopants are selected from a polycationic polymer, a polyanionic polymer and a combination thereof. An exemplary dopant is a poly(sulfonic acid). An exemplary charged organic dopant molecule is poly(styrenesulfonic acid).

The ratio between the polymerizable monomer and the substrate can be within any useful range. In various embodiments, the invention provides a method of forming an electroconductive textile or leather article, wherein the monomer: substrate ratio is from about 1:300 to about 1:5.

The ratio of the polymerizable monomer and the dopant can be within any useful range. In an exemplary embodiment, the invention provides a method of forming an electroconductive textile or leather article, wherein the monomer: dopant ratio is from about 3:1 to about 1:5.

The ratio of the polymerizable monomer and the oxidant can be within any useful range. In various embodiments, the invention provides a method of forming an electroconductive textile or leather article, wherein the monomer:oxidant ratio is from about 1:0.5 to about 1:4.

The ratio of the polymerizable monomer and the catalyst can be within any useful range. In various embodiments, the invention provides a method of forming an electroconductive textile or leather article, wherein the monomer:catalyst ratio is from about 4:0.5 to about 1:3.

In various embodiments, the coating mixture, e.g., for forming the base layer, includes a cosolvent. In an exemplary embodiment, the monomer:co-solvent ratio is from about 1:2 to about 1:20.

In an exemplary embodiment, the invention provides a method of forming an electroconductive textile or leather article, wherein the coating of the substrate is obtained by polymerizing a polymerizable monomer precursor for the electroconductive polymer in contact with the substrate under conditions sufficient to coat the substrate with a polymer coating formed by polymerization of the monomer precursor. An exemplary form of polymerization is oxidative polymerization of the monomer precursor.

In an exemplary embodiment, oxidative polymerization is mediated by an oxidizing agent selected from organic and inorganic persulfates and organic and inorganic peroxides, and a combination thereof.

Although the substrate can be non-treated, or pre-treated directly (e.g., by an impregnation method), an exemplary method consists of two stages: 1) pretreatment of the fiber or fabric substrate for activation and making it suitable for subsequent coating with the conductive coating material and strong attachment of a conductive coating with the use of a deposition technique; 2) subsequent application and strong attachment of a conductive coating.

In various embodiments, the first stage, i.e., pretreatment may be carried out thermally, thermochemically, by treating in hot solutions, or plasma-chemically by plasma treatment, or by other methods. The pre-treatment may be performed for swelling and/or for the formation of unsaturated chemical bonds or uncompensated charges in the substrate material. The pretreatment is effective to ensure more efficient penetration of chemical components into the substrate structure with subsequent application of coating solutions containing a conductive material or monomers polymerizable to form a conductive material. In an exemplary embodiment the pretreatment increases the bonds between the applied conductive material and the substrate material.

In an exemplary embodiment, the substrate is pretreated by contacting it with an aqueous solution of an ionic or non-ionic surfactant.

Pretreatment may be carried out by prolonged impregnation, e.g., by dipping the fabric into a pretreatment solution or suspension.

An example of thermal pretreatment may consist of boiling for 3 or more hours in deionized water, or in weak acidic or weak alkaline solution, e.g., at 100° C. or more.

The aforementioned pretreatment of the substrate is not necessarily impregnation by dipping or boiling and may be a plasma treatment of the substrate. The process consists of treating the substrate in a plasma chamber for a predetermined period of time. The time of treatment depends on the properties of the fabric substrate to be treated and on the parameters of the plasma, such as plasma density and type of active plasma particles. In a majority of cases, oxygen or air plasma is used for this purpose.

The plasma may be based on other working gases, such as argon with minute quantities of chlorine, e.g., for treating fabrics with a substrate made from non-polar polymers. A textile material of any type can be especially efficiently pre-treated with the use of air as a working gas supplied to the plasma chamber. The plasma density recommended for the process should be within the range of 10⁸ to 10¹¹ cm⁻³ at a pressure in the chamber from several milliTorr to 200 milliTorr. Such air plasma can be easily ignited in a capacitive type plasma reactor or in ICP (inductance coupled plasma) type reactor. It should be noted that the temperature of the working gas in the plasma chamber should not exceed the glass transition temperature Tg for polymers of the fabric substrate. The temperature of the electron component of such plasma may be as high or higher than 10² eV. This value is more than sufficient for activation of the molecules in the surface layer of the substrate. Time of treatment depends on the types and characteristics of the substrate material treated but, in an exemplary embodiment, does not exceed several minutes.

An example of an apparatus commercially available for the atmospheric pressure plasma treatment of fabrics is the one (Plasma3™ system) produced by Enercon Industries, Danbury, Conn., USA.

In an exemplary embodiment, the fiber or fabric is submitted to radiation pretreatment is UV (ultraviolet) or VUV (vacuum ultraviolet) pretreatment prior to coating with the electroconductive material. UV treatment may be carried by utilizing, e.g., powerful Hg lamps of high pressure with radiation wavelength above 300 nm. VUV treatment can be carried by using powerful excimer lamps on rare gases such as Krypton that produces radiation at a wavelength of 148 nm and Xenon that produces radiation at a wavelength of 172 nm.

As has been mentioned above, in the context of the present invention the method optionally includes a layer-by-layer deposition of monolayers, i.e., thin mono/molecular layers each having a typical thickness in the range of two to ten of nanometers, but sometimes may be as thick as 300 nm or more.

The conductive coating applied in the second stage is a first layer obtained by means of the aforementioned solution of an anionic or cationic polymer and composed of one or several electronically or ionically conductive, charged polymers (i.e., polyelectrolytes) and a second layer obtained from the aforementioned suspension and composed of oppositely charged conductive nanoparticles. This is achieved by stepwise layer by layer deposition, e.g., a deposition of an oppositely charged species from the polymer solutions and particles from dispersions with washings of the substrate fabric between dippings to remove the excess of charged species.

In some applications, it is desirable that a material incorporating a conductive polymer exhibit anisotropic properties, i.e. non-uniform conductivity, such as a gradient of decreasing conductivity in a particular direction. In an exemplary embodiment, the conductive polymeric material having a conductive polymer film is selectively treated with a solution containing a chemical reducing agent to reduce its conductivity. By selectively reducing portions of the conductive polymer in varying degrees, a gradient of conductivity may be produced in the material. After the conductive polymer has been reduced to a target level, the reducing solution may be removed, e.g., with a hot water rinse.

In various embodiments, conductivity is varied over the substrate by varying the relative concentration of high and low conductivity yarns during construction of a fabric. In the case of woven and knitted fabrics, the relative number of high and low conductivity yarns per inch may be varied in the warp or weft direction or both.

In an exemplary embodiment, the conductivity of the conductive material is varied by varying the thickiness of the layer of the doped conductive polymer, i.e., a thick coating is inherently more conductive than a thinner coating of the same conductive polymer. In an exemplary embodiment, conductivity is controlled by selecting the time period during which polymerization occurs; a shorter polymerization reaction time provides a conductive polymer with a lower conductivity. In various embodiments, the thickness of the conductive polymer varies as a gradient across at least a portion of the substrate, providing a substrate with anisotropic conductivity.

The following examples are provided to illustrate selected embodiments of the invention and do not limit the scope of the invention.

### EXAMPLES

### Method a (PI Coating on Fiber)

Approximately 20 grams of staple fiber was placed in a 400 ml plastic jar equipped with leak proof lid. Approximately 365 ml of dopant/monomer solution was added and the jar was capped with a leak proof lid. The fiber was properly wetted by: shaking the jar manually or rotating the jar by using an electric motor equipped rotating assembly for 15 minutes. Oxidizing agent solution was prepared by dissolving ferric nitrate nonahydrate in 15 ml water. After 15 minutes of wetting, the prepared oxidizing agent solution was added into the jar. The final reaction liquid amount was approximately 380 ml. After the ferric nitrate solution had been added, the reaction solution and the staple fiber were mixed with a Teflon mixing rod for 15 minutes. After 15 minutes of mixing manually, it was continued by shaking or rotating the jar by an electric motor equipped rotation assembly during the entire reaction time. The total reaction time was approximately 3 hours. After 3 hours of reaction time, the reaction liquid was drained and the fiber was rinsed with 380 ml of water twice. Mixing time for each rinse was 10 minutes. After the second rinse, 380 ml of binder solution was added and fiber was mixed with binder solution for 20 minutes. Then the fiber was transferred to a small laundry bag and the excess binder solution was extracted by spinning the laundry bag in a laundry machine. As a last step, the fiber was dried in a convection oven at 80° C. for 20 minutes.

### Method B (TI Coating on Leather)

STEP 1. 6.76 grams of leather substrate was prepared and placed into a reactor. The leather sample for this test was a non-dyed goat skin from Adjon.

STEP 2. A Monomer/Co-solvent/Dopant was prepared in a plastic container, by following method. 1) Obtain the designated amount of water in the “Monomer/Co-solvent/Dopant mixing” container. Weigh the designated amount of dopant and add it into the “Monomer/Co-solvent/Dopant mixing” container. The mixture was well mixed for 3 minutes. 2) the designated amount of co-solvent was weighed in the “Monomer/Co-solvent mixing” container. The designated amount of Monomer was weighed and added into the “Monomer/Co-solvent mixing” container. The mixture was mixed well with a mixing rod/mixer for 1 minute. 3) The Monomer/Co-solvent mixture was added into the “Monomer/Co-solvent/Dopant mixing” container while aggressively mixing the dopant solution with Power mixer and continue to mix for 5 minutes.

STEP 3. The previously prepared Monomer/Co-solvent/Dopant solution was added into the reactor that contains the leather sample. The leather was properly wetted with Monomer/Co-solvent/Dopant mixture by rotating the reactor using an electric motor equipped rotating assembly. Minimum soaking time was 2 hours and longer soaking time (2 to 4 hours) is of use.

STEP 4. Prepared the catalyst/oxidizer solution while the leather pieces were soaking in the Monomer/Co-solvent/Dopant mixture by following method. 1) Obtained the designated amount of Catalyst and dissolved it in the designated amount of water in a beaker by mixing aggressively. Dissolving the catalyst completely takes about 20 minutes. 2) Weighed the designated amount of oxidizer and dissolved it in the catalyst solution that was prepped in the previous step. The oxidant is generally dissolved in the catalyst solution at the time the soaking process was almost complete.

STEP 5. After soaking time was completed, the catalyst/oxidizer solution was added into the reactor and began to count the reaction time. The reaction time was 7 hours at 20° C. Longer reaction times provided more durable conductive coating. After 7 hours of reaction time, the reaction liquid was drained from the reactor and the excess reaction liquid that the skin withheld was removed by spinning the leather sample in a laundry Machine.

STEP 6. Next was either the drying step or the dyeing step. The conductive polymer coated leather can be dyed after drying or directly proceeding to the dyeing process without drying.

### Method C (PI Coating on Textile)

Approximately 1.65 kg of fabric substrate was prepared and placed into in a washing machine.
1. Designated amount of dopant solution was obtained (Table 5). Designated amount of monomer was weighed and dissolved in the dopant solution. Then the volume of Dopant/Monomer mixture was increased to 15 liters by adding tap water.
2. After the washing cycle was started, then the Monomer/Dopant mixture was transferred to the washer.
3. Ran the washing cycle for 10 minutes. Once the fabric had been wet for 10 minutes, designated amount of 34.5 wt. % ferric nitrate nonahydrate solution was added into the washer.
4. Continued the washing cycle for 90 to 120 minutes. Allowed the machine to complete the 1^{st} and 2^{nd} rinse/spin steps.
5. After 2^{nd} rinse/spin completed, set a new 10 minutes washing/spin only cycle. After the washer completed adding water, 1.29 liters of 7.5 wt. % Sodium Hydrogen Carbonate Solution was added into the machine. After the washing/spin cycle completed, proceeded to next step without rinsing.
6. Set another 10 minutes washing/spin only cycle. When the washer completed adding water, 1.27 liters of 1.43% binder solution was added into the washing machine. After the whole cycle was complete, the fabric was transferred into the dryer.
7. The fabric was dried at 80° C. for 40 minutes in a tumble dryer.

### Method D (PI Coating on Black Leather)

Approximately 6.7 grams of Black Leather was placed in a 200 ml plastic jar equipped with leak proof lid. The designated amount (Table 7) of dopant solution and monomer were obtained and the monomer was dissolved in the dopant solution. The dopant/monomer solution was added into the jar and the jar was capped with a leak proof lid. The leather was properly wetted by rotating the jar by using an electric motor equipped rotating assembly. After the pre-soaking was completed, designated amount of oxidant solution was added into the jar. After the oxidant solution was added, the reaction solution and the leather sample were mixed with a Teflon mixing rod for 15 minutes. After 15 minutes of mixing manually, mixing continued by rotating the jar with an electric motor equipped rotation assembly during the entire reaction time. The total reaction time was approximately 3 hours. After 3 hours of reaction time, the reaction liquid was drained and the leather was rinsed with 300 ml of water twice. At every rinse, the leather and rinse water were mixed for 10 minutes. After the second rinse, 300 ml of binder solution was added and leather sample was mixed with binder solution for 20 minutes. The excess binder solution was extracted by spinning the leather sample in a laundry machine. The leather coated with conducting polymer was dried in a tumbler dryer or transferred to a leather softening process directly.

### Method E (LBL Coating on Yarn)

STEP1. A sample of the yarn was prepared on a spool. The yarn of for this test was a non-pretreated yarn. It was made of 80% polypropylene and 20% spandex.

STEP 2. A first solution was prepared in a plastic container, by dissolving 3 g of 50 wt. % polyethyleneimine (PEI) from Aldrich Chemicals Co., Milwaukee, Wis., in 5 liters of tap water, whereby a 0.03 wt. % PEI solution was obtained. The PEI was loaded into a glass beaker and subjected to magnetic stirring. The solution was approximately pH 9. This solution will be hereinafter referred to as Solution No. 1.

STEP 3. A second medium was independently prepared in another plastic container by dispersing 50 g of 20 wt. % graphite from Acheson Graphite Company, in 5 liters of tap water. The final weight percent was approximately 0.2%. The graphite was intensively stirred for a few minutes with a glass rod and then the water was slowly added under stirring. The pH of this dispersion was close to 10. The prepared dispersion will be referred to as Dispersion No. 1.

STEP 4. The yarn sample prepared in Step 1 was immersed through Solution No. 1 with 15 yard per minute speed from spool A to Spool B. After impregnation in Solution No. 1, the treated yarn was dried.

STEP 5. After drying was complete, the sample was immersed through the Dispersion No. 1 with 15 yard per minute speed from spool B to spool A. Upon completion of the immersion step, the treated yard was dried again.

STEP 6. Steps 4 and 5 were repeated sequentially 3 more times. As a result, an electrically conductive yarn was obtained.

### Method F (PI Coating on Bamboo Charcoal)

1) Cut a piece of mesh fabric and loosely bagged 560 grams of Bamboo Charcoal with the mesh fabric and zip tied.
2) Placed the bag in to a custom made circulating reactor equipped with an electric pump. During reaction, the reaction solution circulated from bottom of the reactor through the bamboo charcoal.
3) Monomer/Dopant mixture was prepared by adding 52.5 grams of pyrrole into 8.75 liters of 1 wt. % Anthraquinone-2-sulfonic acid sodium salt solution and mixing well. Then the pyrrole/AQSA mixture was added into the reactor and the liquid was circulated by electric pump for 20 minutes. After 20 minutes circulation, 128 grams of 35% hydrogen peroxide solution was added to the reactor slowly and the circulation was continued for 2 hours.
4) At the end of reaction, after 2-hour reaction time, the reaction solution was drained and the Bamboo Charcoal was rinsed 2 times with 9 liters of water. The rinsing water was circulated for 10 minutes for each rinse.
5) The excess rinse water was drained from the charcoal by hanging the bag in a plastic bucket. After most of the excess rinsing water was drained from the material, the charcoal was dried in an oven with the bag at 70° C. for 2 hours.

### Example 1

A conductive fiber was prepared according to Method A using polyester staple fiber as substrate, pyrrole as a monomer, ferric nitrate nonahydrate as an oxidant, anthraquinone-2-sulfonic acid sodium salt as a dopant, and Poly(vinyl alcohol) as a binder. The results are summarized below in Table 1.

TABLE 1

| | Amount of | Amount of | Amount of | Amount of | Average |
|---|---|---|---|---|---|
| Run | Monomer | Oxidant | Dopant | Binder | Resistance |
| Number | grams | grams | grams | grams | ohm/sq. |
| 1 | 0.364 | 5.106 | 0.608 | 0.270 | 1950 |
| 2 | 0.364 | 5.106 | 0.608 | 0.210 | 1600 |
| 3 | 0.400 | 5.600 | 0.668 | 0.270 | 1025 |
| 4 | 0.400 | 5.600 | 0.668 | 0.210 | 700 |
| 5 | 0.425 | 5.950 | 0.710 | 0.270 | 550 |
| 6 | 0.425 | 5.950 | 0.710 | 0.210 | 505 |

### Example 2

A conductive light blue leather was prepared according to Method B using goat skin as a substrate, 3,4-ethylenedioxythiophene as a monomer, ferric sulfate as a catalyst, sodium persulfate or ammonium persulfate and poly(4-styrenesulfonic acid) (MW 75,000, 30% in water) as a dopant, dimethyl Sulfoxide (DMSO) as a co-solvent. Table 2 shows the optimal formulation. The temperature, reaction time, and co-solvent amount effect are summarized below in Table 3 and Table 4.

TABLE 2

| | Amount of |
|---|---|
| Materials | material grams |
| Goat Skin | 6.76 |
| 3,4-Ethylenedioxythiophene (EDOT) | 0.330 |
| Poly(4-styrenesulfonic acid) (Mw 75,000, 30 in water) | 2.750 |
| Dimethyl Sulfoxide | 2.0 |
| Water amount for monomer/dopant/co-solvent mixture | 25.0 |
| Sodium Persulfate, Na2S2O8 | 0.664 |
| Ferric Sulfate, Fe2(SO4)3 | 0.166 |
| Water amount for oxidant/catalyst solution | 9.5 |

TABLE 3

| Run | Reaction | Reaction Time | Resistance range |
|---|---|---|---|
| Number | Temperature | hour | ohm/sq. |
| 1 | 5° C. | 3 | >10E6 |
| | | 6 | >10E6 |
| | | 24 | 860~945 |
| 2 | 35° C. | 3 | 1800~2500 |
| | | 6 | 1000~1200 |
| | | 24 | 1100~1300 |
| 3 | 50° C. | 3 | 7000~46,00 |
| | | 6 | 6000~29,000 |
| | | 24 | 8000~8300 |
| 4 | 25° C. | 6 | 700~800 |
| | | 9 | 240~290 |
| | | 12 | 245~315 |
| 5 | 15° C. | 6 | 1400~2500 |
| | | 9 | 280~290 |
| | | 12 | 228~240 |

TABLE 4

| Run | Amount of | Reaction Time | Resistance range |
|---|---|---|---|
| Number | DMSO | hour | ohm/sq. |
| 1 | 2 grams | 5 | 240~250 |
| | | 8 | 145~158 |
| | | 17 | 160~220 |
| 2 | 3.5 grams | 5 | 800~820 |
| | | 8 | 470~630 |
| | | 17 | 390~400 |
| 3 | 5 grams | 5 | 6000~7000 |
| | | 8 | 1000~2400 |
| | | 17 | 1800~1900 |

Note:
All material usage is the same with table 2, except the amount of DMSO.

### Example 3

A conductive textile was prepared according to Method C using various type of textile for as substrate, pyrrole as a monomer, ferric nitrate nonahydrate as an oxidant, anthraquinone-2-sulfonic acid sodium salt as a dopant, sodium hydrogen carbonate as a neutralizer and Poly(vinyl alcohol) as a binder. The formulation shows in Table 5 and the results are summarized below in Table 6.

TABLE 5
(Generic coating formulation)

| | Amount of | |
|---|---|---|
| Materials | materials | |
| Textile | 1.56 ± 0.5 | kg |
| Pyrrole | 25.5 | grams |
| 0.8 wt. % Anthraquinone-2-sulfonic acid sodium | 5.01 | liters |
| salt solution | | |
| 34.5 wt. % Ferric nitrate nonahydrate solution | 0.978 | kg |
| Water amount for monomer/dopant | 10 | liters |
| 7.5 wt. % Sodium Hydrogen Carbonate Solution | 1.29 | liters |
| 1.43% Poly(vinyl alcohol) solution | 1.27 | liters |

TABLE 6

| | | | Average |
|---|---|---|---|
| Run | | | Resistance |
| Number | Weight | Substrate content | ohm/sq. |
| 1 | 240 GM/M2 | 53% Polyester, 38% Nylon, 9% | 7180 |
| | | Spandex; Knitted | |
| 2 | 240 GM/M2 | 53% Polyester, 38% Nylon, 9% | 2131 |
| | | Spandex; Knitted | |
| 3 | 250 GM/M2 | 55% Nylon, 45% PU; Knitted | 1030 |
| 4 | 220 GM/M2 | Face: 100% Polyurethane Coated, | 5861 |
| | | Back: 100% Polyester; Knitted | |
| 6 | 200 GM/M2 | 100% Polyester; Knitted | 5775 |
| 7 | 300 GM/M2 | 100% Polyester; Knitted | 3367 |
| 8 | 245 GM/M2 | 94% Polyester, 6% Lycra; Knitted | 5125 |
| 9 | 315 GM/M2 | 100% Polyester; Knitted | 1443 |

### Example 4

A conductive black leather was prepared according to Method D using black Goat leather as a substrate, pyrrole as a monomer, 34.5 wt. % ferric nitrate nonahydrate solution as an oxidant solution, 0.8 wt. % anthraquinone-2-sulfonic acid sodium salt solution as a dopant solution, and 0.27% Poly(vinyl alcohol) solution as a binder solution. The formulation and results are summarized below in Table 7. Only the leather sample that was used in run number was pre-soaked in water for 4 hour prior to coating for comparison.

TABLE 7

| | | | Dopant | Oxidant | | Average |
|---|---|---|---|---|---|---|
| Run | | Monomer | solution | solution | | Resistance |
| Number | | grams | grams | grams | Pre-soaking time | ohm/sq. |
| 1 | Formulation 1 | 0.3506 | 74.2 | 13.5 | 4 hours in water | 695 |
| 2 | Formulation 1 | 0.3506 | 74.2 | 13.5 | 1 hour in | 369 |
| | | | | | dopant/monomer | |
| | | | | | mixture | |
| 3 | Formulation 2 | 0.2455 | 52 | 9.4 | 1 hour in | 1425 |
| | | | | | dopant/monomer | |
| | | | | | mixture | |
| 4 | Formulation 3 | 0.1403 | 29.7 | 5.4 | 2 hour in | 1925 |
| | | | | | dopant/monomer | |
| | | | | | mixture | |
| 5 | Formulation 3 | 0.1403 | 29.7 | 5.4 | 4 hour in | 2000 |
| | | | | | dopant/monomer | |
| | | | | | mixture | |

### Example 5

28.9 grams of conductive yarn was prepared according to Method E using a yarn that contains 80% of polypropylene and 20% spandex fibers. After 3 bilayer coating the conductivity was measured by stacking 16 layer yams together. The resistance reading was 100 k ohm/cm of 16 layers of yam.

### Example 6

### Conductive Coating on Bamboo Charcoal

1) A piece of mesh fabric was cut and 560 grams of Bamboo Charcoal loosely bagged with the mesh fabric and zip tied.
2) Placed the bag in to a custom made circulating reactor equipped with an electric pump. During reaction, the reaction solution circulated from bottom of the reactor through the bamboo charcoal.
3) Monomer/Dopant mixture was prepared by adding 52.5 grams of pyrrole into 8.75 liters of 1 wt. % anthraquinone-2-sulfonic acid sodium salt solution and mixing well. Then the pyrrole/AQSA mixture was added into the reactor and the liquid was circulated by electric pump for 20 minutes. After 20 minutes circulation, 128 grams of 35% hydrogen peroxide solution was added to the reactor slowly and the circulation was continued for 2 hours.
4) At the end of reaction, after 2-hour reaction time, the reaction solution was drained and the Bamboo Charcoal was rinsed 2 times with 9 liters of water. The rinsing water was circulated for 10 minutes for each rinse.
   The excess rinse water was drained from the charcoal by hanging the bag in a plastic bucket. After most of the excess rinsing water was drained from the material, the charcoal was dried in an oven with the bag at 70° C. for 2 hours.

The present invention provides, inter alia, novel methods of forming conductive fibers, fabrics and other substrates prepared by the methods of the invention. While specific examples have been provided, the above description is illustrative and not restrictive. Any one or more of the features of the previously described embodiments can be combined in any manner with one or more features of any other embodiments in the present invention. Furthermore, many variations of the invention will become apparent to those skilled in the art upon review of the specification. The scope of the invention should, therefore, be determined not with reference to the above description, but instead should be determined with reference to the appended claims along with their full scope of equivalents.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

What is claimed is:

1. An electroconductive staple fiber, comprising:
(a) a staple fiber substrate, stably coated with,
(b) an electroconductive organic polymer, comprising:
(i) a charged organic polymer bearing a plurality of charged moieties of a first polarity;
(ii) a charged organic dopant molecule bearing a charge of a second polarity, wherein said first polarity is opposite said second polarity; and
(c) a polymeric binder coating at least a portion of said electroconductive polymer.

2. The staple fiber according to claim 1, wherein said staple fiber substrate comprises, a natural fiber, a synthetic fiber, and combination thereof.

3. The staple fiber according to claim 1, wherein said electroconductive polymer is a member selected from polyanionic polymers and polycationic polymers.

4. The staple fiber according to claim 3, wherein said electroconductive polymer is a polycationic polymer and said dopant is an anionic organic compound.

5. The staple fiber according to claim 1, wherein said charged organic dopant molecule is a member selected from substituted or unsubstituted arenes and substituted or unsubstituted heteroarenes.

6. The staple fiber according to claim 5, wherein said charged organic dopant molecule is a substituted or unsubstituted quinone.

7. The staple fiber according to claim 6, wherein said charged organic dopant molecule is substituted anthraquinone.

8. The staple fiber according to claim 7, wherein said charged organic dopant molecule is a salt of anthraquinone-2-sulfonic acid.

9. The staple fiber according to claim 4, wherein said electroconductive polymer is a member selected from poly(substituted or unsubstituted arenes), and poly(substituted or unsubstituted heteroarenes).

10. The staple fiber according to claim 9, wherein said electroconductive polymer is polypyrrole.

11. The staple fiber according to claim 10, wherein the monomer:dopant ratio of said fiber is from about 3:1 to about 1:4.

12. The staple fiber according to claim 10, wherein the monomer: binder ratio is from about 1:0.2 to about 1:4.

13. The staple fiber according to claim 10, wherein the conductivity of said fiber is from about 10 ohm/m² to about 10⁸ ohm/m².

14. The staple fiber according to claim 1, wherein said binder polymer is a member selected from polymeric alkyl alcohols, polymeric aryl alcohols, and polymeric heteroaryl alcohols.

15. The staple fiber according to claim 12, wherein said binder is poly(vinyl alcohol).

16. The staple fiber according to claim 1, wherein said staple fiber is a member of a plurality of staple fibers.

17. The staple fiber according to claim 14, wherein said staple fiber is a component of a woven or non-woven fabric.

18. A method of forming an electroconductive staple fiber, said method comprising, coating a fiber substrate with:
(a) an electroconductive polymeric coating comprising,
(i) a charged organic polymer bearing a plurality of charged moieties of a first polarity;
(ii) a charged organic dopant molecule bearing a charge of a second polarity, wherein said first polarity is opposite said second polarity,
under conditions sufficient to adhere said electroconductive polymer to said fiber substrate; and
(b) a polymeric binder, under conditions sufficient to adhere said polymeric binder to at least a portion of the electroconductive polymer coated on said fiber substrate.

19. The method of claim 18, wherein said coating of said fiber substrate is obtained by polymerizing a polymerizable monomer precursor for said electroconductive polymer in contact with said fiber substrate under conditions sufficient to coat said fiber substrate with a polymer coating formed by polymerization of said monomer precursor.

20. The method according to claim 18, wherein said polymerizing is obtained via oxidative polymerization of said monomer precursor.

21. The method according to claim 18, wherein said polymer coating is essentially electrically neutral, and comprises a plurality of basic or acidic moieties.

22. The method according to claim 18, wherein, prior to step (b), said polymer is contacted with a member selected from an acid and a base of sufficient strength to protonate at least a portion of said plurality of basic moieties or deprotonate at least a portion of said plurality of acidic moieties on said polymer.

23. The method according to claim 18, wherein said monomer:fiber ratio is from about 1:500 to about 1:5.

24. The method according to claim 18, wherein said monomer:dopant ratio is from about 3:1 to about 1:4.

25. The method according to claim 18, wherein said monomer:catalyst ratio is from about 1:7 to about 1:25.

26. An electroconductive textile or leather article, comprising:
(a) a textile or leather substrate, stably coated with,
(b) an optically transparent electroconductive organic polymer, comprising:
(i) an organic polymer bearing a plurality of aromatically conjugated moieties; and
(ii) a charged organic dopant molecule,
wherein said optically transparent electroconductive organic polymer is essentially clear and colorless in appearance.

27. The article according to claim 26, wherein said aromatically conjugated moieties are members selected from substituted or unsubstituted aryl, substituted or unsubstituted heteroaryl moieties, and a combination thereof.

28. The article according to claim 25, wherein said aromatically conjugated moieties are substituted thiophene moieties.

29. The article according to claim 26, wherein said electroconductive organic polymer is poly(3,4-ethylenedioxythiophene).

30. The article according to claim 24, wherein said dopant is a member selected from a polycationic polymer, a polyanionic polymer and a combination thereof.

31. The article according to claim 28, wherein said charged organic dopant molecule is a poly(sulfonic acid).

32. The article according to claim 29, wherein said charged organic dopant molecule is poly(styrenesulfonic acid).

33. The article according to claim 24, wherein said article is a textile article and said substrate is a member selected from a fiber, a non-woven fabric, and a woven fabric.

34. The article according to claim 24, having a surface resistance of from about 10 Ohms/sq. to about 10⁶ Ohms/sq.

35. The article according to claim 24, wherein said article is capable of transferring magnetic energy.

36. An antenna comprising an article according to claim 24.

37. A method of forming an electroconductive textile or leather article, said method comprising:
(a) coating a textile or leather substrate with,
(i) an optically transparent electroconductive organic polymer comprising a plurality of aromatically conjugated moieties; and
(ii) a charged organic dopant molecule,
wherein said optically transparent electroconductive organic polymer is essentially clear and colorless in appearance.

38. The method according to claim 37, wherein said aromatically conjugated moieties are members selected from substituted or unsubstituted aryl, substituted or unsubstituted heteroaryl moieties, and a combination thereof.

39. The method according to claim 38, wherein said aromatically conjugated moieties are substituted thiophene moieties.

40. The method according to claim 39, wherein said electroconductive organic polymer is poly(3,4-ethylenedioxythiophene).

41. The method according to claim 39, wherein said dopant is a member selected from a polycationic polymer, a polyanionic polymer and a combination thereof.

42. The method according to claim 40, wherein said charged organic dopant molecule is a poly(sulfonic acid).

43. The method according to claim 42, wherein said charged organic dopant molecule is poly(styrenesulfonic acid).

44. The method according to claim 37, wherein said monomer:substrate ratio is from about 1:300 to about 1:5.

45. The method according to claim 37, wherein said monomer:dopant ratio is from about 3:1 to about 1:5.

46. The method according to claim 37, wherein said monomer:oxidant ratio is from about 1:0.5 to about 1:4.

47. The method according to claim 37, wherein said monomer:catalyst ratio is from about 4:0.5 to about 1:3.

48. The method according to claim 37, wherein said monomer:co-solven ratio is from about 1:2 to about 1:20.

49. The method according to claim 37, wherein said coating of said substrate is obtained by polymerizing a polymerizable monomer precursor for said electroconductive polymer in contact with said substrate under conditions sufficient to coat said substrate with a polymer coating formed by polymerization of said monomer precursor.

50. The method according to claim 49, wherein said polymerizing is obtained via oxidative polymerization of said monomer precursor.

51. The method according to claim 50, wherein said oxidative polymerization is mediated by an oxidizing agent selected from organic and inorganic persulfates and organic and inorganic peroxides, and a combination thereof.
